(19) United States
(12) Patent Application Publication
(10) Pub. No.: US 2024/0008457 A1
(43) Pub. Date: Jan. 11, 2024

(54) INTERACTIVE DEVICE FOR GALLINACEOUS BIRDS AND METHOD FOR CHECKING AND MONITORING THE PHYSICAL ACTIVITY OF GALLINACEOUS BIRDS

(71) Applicant: Albino CALLOU BARROS, Eusébio (BR)

(72) Inventor: Albino CALLOU BARROS, Eusébio (BR)

(21) Appl. No.: 18/036,348

(22) PCT Filed: Jan. 21, 2021
(86) PCT No.: PCT/BR2021/050029

§ 371 Date: May 22, 2023

(30) Foreign Application Priority Data
Nov. 12, 2020 (BR) 10 2020 023170-7
Jan. 18, 2021 (BR) 10 2021 000918-7

(51) Int. Cl. A01K 45/00; G05B 15/02

(52) U.S. Cl. CPC A01K 45/00; G05B 15/02

(57) ABSTRACT

The present invention refers to an interactive device designed to interact with poultries, wherein the interactive device comprises a poultry-shaped dummy supported on a mobile motorized base, and the poultry-shaped dummy has several elements providing an interactive activity for the poultry.

### FIELD OF THE INVENTION

This patent application claims internal priority related to process filed under No. BR 10 2020 023170-7, on Nov. 12, 2020, according to Brazilian IP Law No. 9.279, of May 14, 1996.

The present invention refers to the field of interactive electronic devices, and in particular it deals with a device specifically designed to interact with poultries, preferably including roosters. To this end, said device presents a poultry-shaped dummy with various interaction elements such as circuits and electronic sensors, so that the bird can interact with the device in question in order to create a physical and recreational activity for the bird.

### BACKGROUND OF THE PRIOR ART

As is widely known by person skilled in the art involved in the bird's industry, poultries are an order of birds that includes chickens, turkeys and pheasants, wherein this order is particularly characterized by birds with a short beak, strong legs and short, rounded wings. Chickens and roosters are, respectively, adult female and male specimens of this order of birds. In particular, it is necessary to separate the roosters from a litter because if they remain together, it is customary for these roosters to fight among themselves, which results in serious consequences, such as serious injuries or even death of one of the roosters.

Because roosters are extremely territorial poultries, these birds feel the need to have a strong and healthy physique, in addition to active and assertive behavior. In this way, roosters in particular are a type of bird that certainly benefit from physical and recreational activities to develop their physical capacities, and to satisfy their behavioral needs, in particular that of always maintaining regular physical activity.

In this context, the prior art has some solutions, in particular document TWM332512 that describes a rooster model comprising a rigid body, a soft cover and a base, wherein the rigid body which refers to a rooster-shaped body and the flexible cover are attached to the motorized base. The base is arranged at the lower end of the body, and it can support the weight of the body, and the body does not fall when it is shaken.

However, this solution only presents a rooster-like dummy attached to a base, thus it does not have elements that react with the bird, serving only to receive reactions from it.

Considering the above, the prior art would clearly benefit from the introduction of an interactive device that provides physical activity for a poultry in order to satisfy its physical and mental needs, with the aim of providing its well-being, mainly due to the fact that there are few options for recreational activities for poultries.

### BRIEF DESCRIPTION OF THE INVENTION

In a first aspect, the present invention has as main objective to present an interactive electronic device specifically designed to interact with poultries, preferably comprising roosters, in order to provide a recreational activity for the bird. In particular, it is known that roosters are extremely territorial gallinaceous birds, due to their coexistence with bloody disputes between themselves, so the device of the present invention aims both to exercise these poultries and to satisfy their territorial instinct to avoid unnecessary conflicts. Furthermore, the device of the present invention also provides conditions for evaluating which poultries are more apt for reproduction.

To achieve this object, said device comprises a poultry-shaped dummy, such as a rooster, which has a rigid internal case comprising of two side parts diametrically opposed to each other, wherein when fitted together form the shape of a bird. Furthermore, said case is made of polymeric material, preferably PVC (Vinyl Chloride Polymers), PP (polypropylene), PS (polystyrene) or ABS (acrylonitrile butadiene styrene).

Both side parts with the said case present several orifices corresponding to the contacts of a flexible circuit board, which is activated through contact with a rubber glove that is located close to the bird's foot. Furthermore, both side parts comprise several orifices to connect electronic components. The two side parts are coupled, making the dummy seem a gallinaceous bird. When coupled together, the side parts form a posterior cavity to fit a straight PU tube joint that receives a synthetic feather tail.

In addition, said poultry-shaped dummy comprises a flexible and soft outer layer, which is composed of polymeric material, preferably PVC (Vinyl Chloride Polymers), TR (Thermoplastic Rubber) or TPU (Thermoplastic Polyurethane). The flexible outer cover comprises several orifices corresponding to those of the aforementioned side parts, more specifically the orifices corresponding to the contacts of the flexible circuit board. In addition to these orifices, the flexible cover comprises other orifices for receiving a closing lace of said flexible cover, and several other orifices for receiving synthetic feathers.

The device of the present invention also comprises a base that supports said poultry-shaped dummy, said motorized base comprising a metallic motorized-chassis treadmill, or ABS, activated by a remote controller with wireless communication. The base will be fixed to the poultry-shaped dummy through a metal screw and will also be responsible for powering electronic elements thereof. The base controller is a joystick-type control with an ESP32-type processor, which will send commands for moving and issuing sound effects, based on 3-axis joysticks and buttons for activating functions.

In a second aspect, the present invention refers to a method of operation of the aforementioned device, wherein its use is from the mechanical activation of the contacts of the flexible circuit boards with the PVC gloves to be worn by the bird, resulting in a sound and visual response, and in order to have the scores and records of each rooster saved by an external software for later consultation.

### BRIEF DESCRIPTION OF THE DRAWINGS

The subject matter of this Invention will be completely clear in its technical aspects from the detailed description that will be made based on the figures listed below, wherein:

FIG. 1 shows a perspective view of the fully assembled interactive device for poultries;

FIG. 2 shows an exploded perspective view of the interactive device for poultries;

FIG. 3 shows a perspective view of the poultry-shaped dummy with the flexible cover detached;

FIG. 4 shows a front view of the poultry-shaped dummy with the flexible cover detached;

FIG. 5 shows an exploded perspective view of the poultry-shaped dummy in order to show its internal components;

FIG. 6 shows a side view of one of the side parts comprised by the poultry-shaped dummy in order to show its internal position;

FIG. 7 shows an exploded side view of the synthetic feather attached to the rear position of the poultry-shaped dummy;

FIG. 8 shows a perspective view of the base control of the interactive device for poultries; and

FIG. 9 shows a flat view of the interface that monitors the use of the interactive device for poultries.

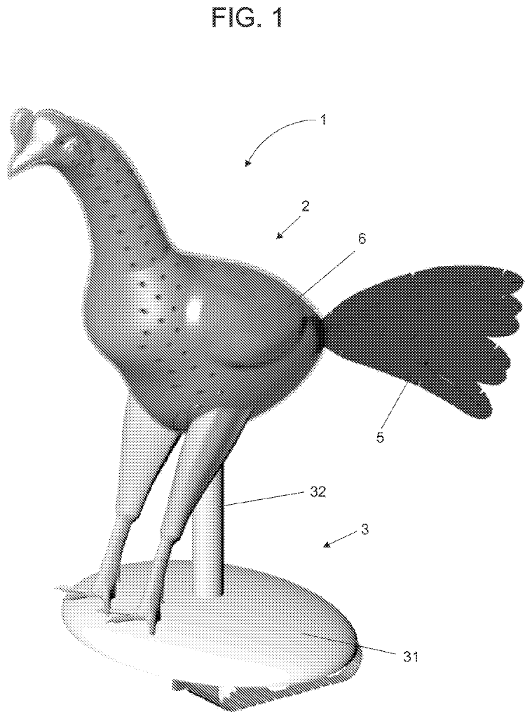

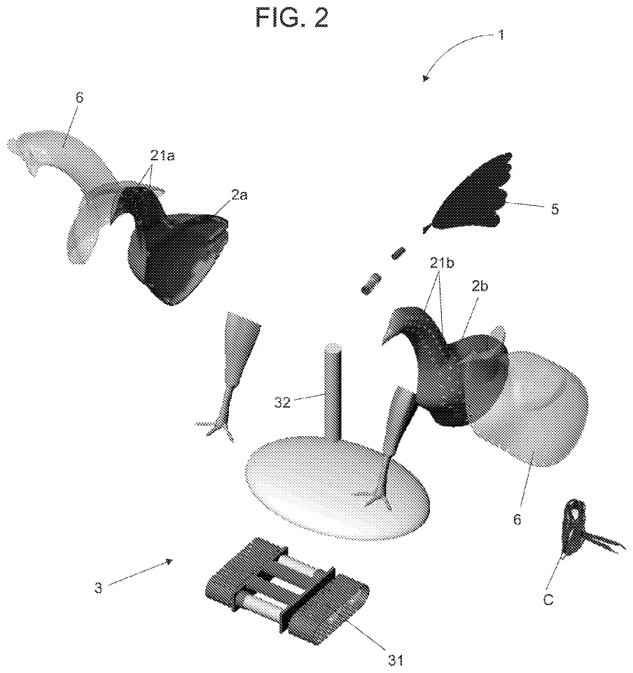

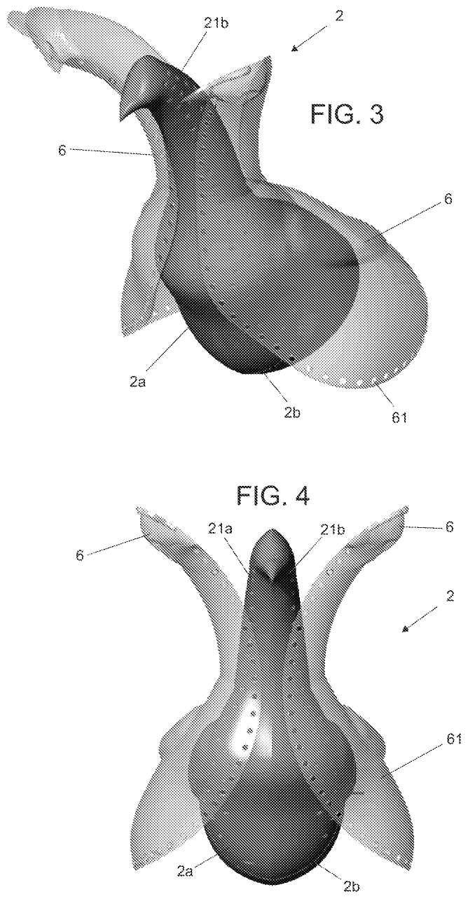

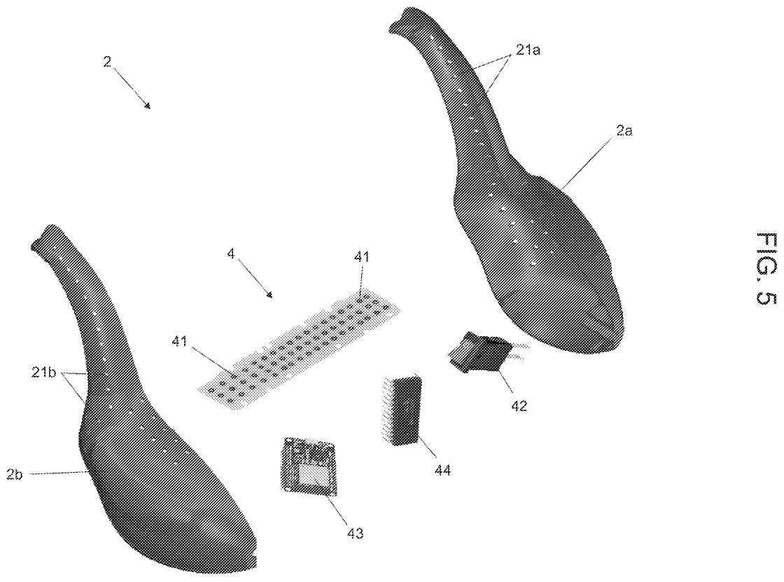

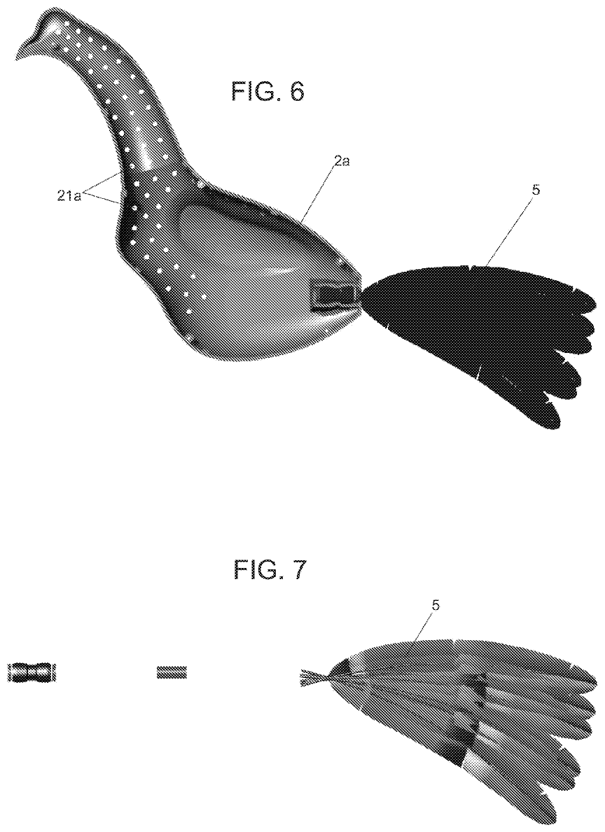

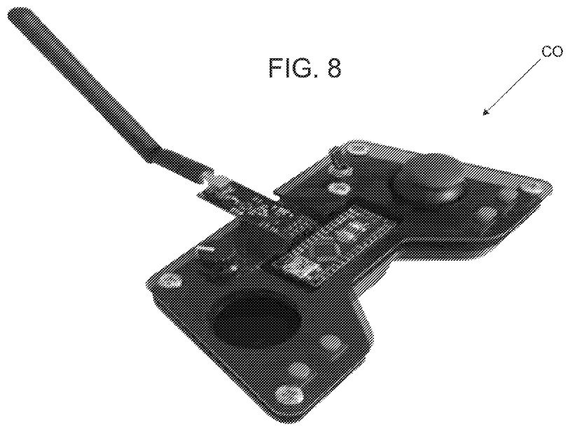

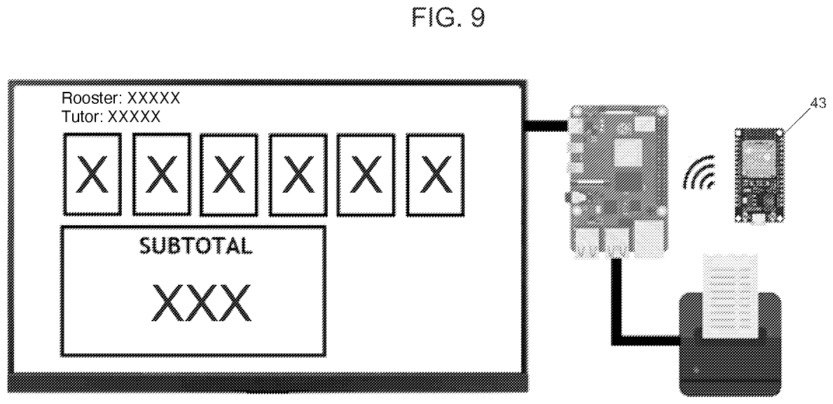

### DETAILED DESCRIPTION OF THE INVENTION

In accordance with the objectives showed through the brief description, in a first aspect, the present invention refers to an interactive device for poultries comprising an interactive device (1) specifically designed to interact with poultries, preferably comprising roosters, wherein the interactive device (1) comprises a poultry-shaped dummy (2) such as the rooster-shaped, wherein said dummy (2) is supported on a base (3).

In an embodiment of the present invention, the dummy (2) is comprised of two side parts (2a) and (2b) which are diametrically opposed to each other so that, when fitted, they form the shape of a bird for the dummy (2). Both side parts (2a) and (2b) are made of polymeric material, preferably PVC (Vinyl Chloride Polymers), PP (polypropylene), PS (polystyrene) or ABS (acrylonitrile butadiene styrene).

In an embodiment of the present invention, the side part (2a) comprises several orifices (21a) corresponding to the contacts (41) of a flexible circuit board (4), which is housed inside the side part (2a). In addition to the orifices (21a), the side part (2a) comprises another orifice for fitting a SPST switch (42).

In an embodiment of the present invention, the side part (2b) comprises several orifices (21b) corresponding to the contacts (41) of a flexible circuit board (4) which is housed inside the side part (2b). In addition to the orifices (21b), the side part (2b) comprises another orifice for fitting a microprocessor (43), another orifice for fitting a port expander (44) for circuit boards, and a last orifice for receiving a metallic nut that closes both side parts (2a) and (2b) to conform the poultry-shaped dummy (2). The microprocessor (43) is an ESP-32 type processor.

Furthermore, the side parts (2a) and (2b), when fitted together, form a posterior cavity for fitting a straight PU tube joint that receives a synthetic feather tail (5).

In another aspect of the present invention, the poultry-shaped dummy (2) comprises a flexible cover (6), composed of two parts diametrically opposed to each other, and which is made of polymeric material, preferably PVC (Polymers of chloride of Vinyl), TR (Thermoplastic Rubber) or TPU (Thermoplastic Polyurethane). The flexible cover (6) covers the dummy (2) and also comprises several orifices corresponding to the orifices (21a) and (21b) of the side parts (2a) and (2b). The flexible cover (6), in addition to comprising the orifices, also comprises a corresponding orifice with the orifice in the side part (2a) that receives the key (42); and furthermore, the flexible cover (6) comprises several orifices to receive a common lace (C), which closes said two parts of the flexible cover (6). The flexible cover (6) still comprises several other orifices that receive synthetic feathers.

Thus, the dummy (2) houses the interactive elements of the device (1), in particular the contacts (41), wherein its activation is monitored by the microprocessor (43).

In another aspect of the present invention, the base (3) that supports the poultry-shaped dummy (2) comprises a metallic motorized treadmill (31) and ABS. The treadmill (31) is moved by a remote controller (CO) with wireless communication, and the base (3) is attached to the dummy (2) through a metal screw attached to a metal rod (32). In addition, the base (3) has a battery responsible for powering the device (1), therefore it powers both the treadmill (31) and also the electronic elements of the dummy (2), in particular the microprocessor (43), through flexible cables.

The controller (CO) of the treadmill (31) is an ESP32 joystick-type control, and which will send the commands for moving and issuing sound effects based on three-axis joysticks and buttons for activating the functions.

In a second aspect, the present invention refers to a method for controlling and monitoring the physical activity of a poultry, said method being executed by the device (1) described herein. In this sense, this method comprises the following steps:
(a) online data registration on the device (1);
(b) manual control of the device (1);
(c) interaction of said poultry with the device (1), said interaction being stimulated by the manual control of the device (1) according to step (b);
(d) gathering data from the interaction of the poultry with the device (1);
(e) conversion of the data acquired in step (d) into a sound response and a visual response; and
(f) digital consultation or printed consultation of the visual response obtained according to step (e), considering that:
(g) optionally, a digital consultation or printed consultation of records is performed;
   being the steps (a) to (f) or steps (a) to (g) monitored by online monitoring through a WEB platform.

In an embodiment of the present invention, the method described herein encompasses the following technical characteristics associated with any of steps (a) to (f) or (a) to (g):
the online registration in step (a) comprises registration of a tutor, registration of said poultry, and registration of said physical activity;
the manual control of the device (1) in step (b) is made by means of a remote controller (CO);
the interaction of said poultry with the device (1) occurs through marks of the said poultry beak on the contacts (41) of the device (1);
any one of the contacts (41) that is hit by the gloves is activated and, therefore, performs the data gathering in step (d);
the data conversion in step (e) is made by a microprocessor (43) of the device (1);
the digital consultation in step (f) or in step (g) is performed through online monitoring; and
the printed consultation in step (f) or in step (g) is performed through printed reports.

In an embodiment of the present invention, the visual response comprises: a score display measuring the performance of the reactions of said poultry in the said physical activity; data visualization of said poultry in the said physical activity; visualization of tutor data; date visualization of said physical activity; and time visualization of said physical activity.

In an embodiment of the present invention, the logs comprise: a log of registered poultries; records of registered tutors; or a log of registered physical activities.

In an embodiment of the present invention, each physical activity registered in the log of registered physical activities comprises a respective visual response.

In an embodiment of the present invention, said respective visual response comprises a score display measuring the performance of the reactions of a respective poultry involved in said respective visual response; data visualization of said respective poultry; data visualization of a respective tutor; date visualization of said respective visual response; and time visualization of said respective visual response.

In an embodiment of the present invention, in the method described herein, the control and monitoring of the physical activity of said poultry is performed by software with an interactive interface that provides said digital consultations, printed consultations and said online registration.

In an embodiment of the present invention the remote controller (CO) is an ESP32 joystick-type control.

In an embodiment of the present invention, in the method described herein, the use of the interactive device (1) results from the activation of the contacts (41), thus generating a sound and visual response to be counted the scores and registered in the log of each poultry to subsequent consultation. Still, it is possible to determine the time values for each workout in a dynamic or standardized way. Poultry's tutor will receive the sum of his points simultaneously during the course of the activity and at the end of the training the final score will be presented, and the report will be printed with the last data, as well as the time and date.

For controlling and monitoring the activation of the contacts (41) of the device (1), the present invention shows the said software with an interactive interface for online consultation and registration with the following functionalities:
Registration of tutors and poultries;
Registration of physical activities;
Consultations of log points, poultries and physical activities;
Online monitoring through WEB platform;
Monitor for scoring points;
Panel for device (1) configuration and output.

The central control of the software is stored in a Raspberry Pi-type CPU, which is also connected to a monitor, printer and ESP32 processor. Said CPU will output the physical activities of a bird, in addition to showing the results and printing the reports.

More specifically, the flexible circuit board (4), which is connected to the microprocessor (43), and with the actuation of at least one of the contacts (41), the microprocessor (43) will translate each actuation into a configurable address value via software, and then it will send the data to said Raspberry PI CPU.

In an application example, the device (1) is placed on a rubber or soft mat arranged in a free flat space of around 6 m² in front of a bird. This bird in turn will recognize the similarity of the dummy (2) as another bird, something that instigates the bird's territorial instinct; thus, the beginning of physical activity will occur with the reactions on the contacts (41) and consequently the system is activated computing the marks.

The Raspberry PI CPU will receive the data via a wireless connection from the microprocessor (43), display the results, subtotal, names and all information relevant to the operation on the screen, and emit sounds according to the marks and phases of physical activity—such as end and start. At the end of the physical activity, the final result will be displayed on the screen and a report will be printed with all the information on the poultry's performance, such as: poultries, tutor, marks, date, time.

In an embodiment of the present invention, in the method described herein, the poultry comprises a rooster.

It should be understood that the present description does not limit application to the details described herein and that the invention is capable of other embodiments and being practiced or performed in a variety of ways within the scope of the claims. While specific terms have been used, such terms are to be interpreted in a generic and descriptive sense, and not for the purpose of limitation.

1. An INTERACTIVE DEVICE (1) FOR POULTRIES, characterized in that it comprises an interactive device (1) designed to interact with poultries, wherein the interactive device (1) comprises a poultry-shaped dummy (2) supported on a base (3).

2. The DEVICE (1), according to claim 1, characterized in that the dummy (2) comprises two side parts (2a) and (2b) made of polymeric material, wherein when they are fitted together form a posterior cavity for fitting a straight PU tube joint that receives a synthetic feather tail (5).

3. The DEVICE (1), according to claim 1, characterized in that the side part (2a) comprises orifices (21a) corresponding to the contacts (41) of a flexible circuit board (4) that is housed inside the side part (2a), and another orifice for fitting a SPST switch (42).

4. The DEVICE (1), according to claim 1, characterized in that the side part (2b) comprises orifices (21b) corresponding to the contacts (41) of another flexible circuit board (4), which is housed inside the side part (2b); the two side parts comprise several orifices to couple electronic components; wherein both side parts (2a) and (2b) will be coupled together to form the poultry-shaped dummy (2).

5. The DEVICE (1), according to claim 4, characterized in that the microprocessor (43) is an ESP-32 type processor.

6. The DEVICE (1), according to claim 1, characterized in that the dummy (2) comprises a flexible cover (6), consisting of two parts diametrically opposed to each other, and which is made of material polymeric, and the flexible cover (6) covers the dummy (2), and also comprises orifices corresponding to the orifices (21a) and (21b) of the side parts (2a) and (2b), in addition to a corresponding orifice with the orifice in the side part (2a) that receives the SPST switch (42); and also another orifice to receive a common lace (C), which closes the said two parts of the flexible cover (6), the flexible cover (6) comprising other orifices that receive synthetic feathers.

7. The DEVICE (1), according to claim 1, characterized in that the base (3) comprises a metallic motorized treadmill (31) and ABS, and which is moved by a remote controller (CO) with wireless communication, and which will send commands for moving and issuing sound effects based on three-axis joysticks and buttons for activating functions, and the base (3) is attached to the dummy (2) through a metal screw attached to a metal rod (32).

8. The DEVICE (1), according to claim 7, characterized in that the base (3) has a battery responsible for powering the treadmill (31) and the device (1).

9. The DEVICE, according to claim 1, characterized in that poultries include roosters; the two side parts (2a) and (2b) are made of polymeric material based on PVC, PP, PS or ABS; the flexible cover (6) is made of polymeric material based on PVC, TR or TPU; and the remote controller (CO) is an ESP32 joystick control.

10. A CONTROL AND MONITORING METHOD OF PHYSICAL ACTIVITY OF POULTRY, said method being performed by the device (1), defined according to claim 1, and characterized in that it comprises the following steps:
(a) online data registration on the device (1);
(b) manual control of the device (1);
(c) interaction of said poultry with the device (1), wherein said interaction is stimulated by the manual control of the device (1) according to step (b);
(d) gathering data from the interaction of the poultry with the device (1);
(e) conversion of the data acquired in step (d) into a sound response and a visual response; and
(f) digital consultation or printed consultation of the visual response obtained according to step (e), wherein:
(g) optionally, a digital consultation or printed consultation of records is performed;
wherein steps (a) to (f) or steps (a) to (g) are monitored by online monitoring through a WEB platform.

11. The METHOD, according to claim 10, characterized in that:
the online registration in step (a) comprises registration of a tutor, registration of said poultry, and registration of said physical activity;
the manual control of the device (1) in step (b) is performed by means of a remote controller (CO);
the interaction of said poultry with the device (1) occurs through reactions of said poultry on the contacts (41) of the device (1);
any one of the contacts (41) that is hit by the glove is activated and, therefore, performs the data gathering in step (d);
the data conversion in step (e) is performed by a microprocessor (43) of the device (1);
the digital consultation in step (f) or in step (g) is performed through online monitoring; and
the printed consultation in step (f) or in step (g) is performed through printed reports.

12. The METHOD, according to claim 1, characterized in that the visual response comprises visualization of marks measuring the performance of the reactions from said poultry in the said physical activity, data visualization of said poultry in the said physical activity; visualization of tutor data, visualization of the date of said physical activity, and visualization of the time of said physical activity.

13. THE METHOD, according to claim 1, characterized in that the records comprise records of registered poultry, records of registered tutors, or records of registered physical activities.

14. THE METHOD, according to claim 13, characterized in that each physical activity registered in the records of registered physical activities comprises a respective visual response.

15. THE METHOD, according to claim 14, characterized in that the respective visual response comprises: a visualization of the marks measuring the performance of the reactions of a respective poultry involved in said respective visual response; data visualization of said respective poultry; data visualization of a respective tutor; data visualization of said respective visual response; and time visualization of said respective visual response.

16. The METHOD, according to claim 1, characterized in that the control and monitoring of the physical activity of said poultry is performed by software with an interactive interface, providing said digital consultation, printed consultations and said online registration.

17. The METHOD, according to claim 1, characterized in that the remote controller (CO) is an ESP32 joystick control and the poultry includes a rooster.
